(19) United States
(12) Patent Application Publication
(10) Pub. No.: US 2006/0293463 A1
(43) Pub. Date: Dec. 28, 2006

(54) Compositions for brightness enhancing films

(75) Inventors: Daniel Robert Olson, Voorheesville, NY (US); Paul Michael Smigelski JR., Schenectady, NY (US); James Alan Resue, Scotia, NY (US); Bret Ja Chisholm, West Fargo, ND (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/171,032

(22) Filed: Jun. 28, 2005

(51) Int. Cl. C08F 120/10

(52) U.S. Cl. 525/330.3

(57) ABSTRACT

Disclosed is a brightness enhancing film composition comprising a multifunctional (meth)acrylate, a substituted or unsubstituted naphthyl (meth)acrylate monomer, an arylether (meth)acrylate and an optional polymerization initiator. The composition was found to efficiently cure under typical conditions employed for the rapid, continuous production of cured, coated films. Such cured compositions exhibit excellent relative degree of cure under a variety of processing conditions. Disclosed also are articles comprising the brightness enhancing film composition comprising a multifunctional (meth)acrylate, a substituted or unsubstituted naphthyl (meth)acrylate monomer, an arylether (meth)acrylate and an optional polymerization initiator. The article may be a multilayer article comprising a substrate.

### BACKGROUND

The invention relates generally to curable (meth)acrylate compositions and, more specifically to ultraviolet (UV) radiation curable (meth)acrylate compositions. The compositions are suitable for optical articles and particularly for brightness enhancing films.

In backlight computer displays or other display systems, brightness enhancing films are commonly used to direct light. Such films enhance the brightness of the display viewed by a user and allow the system to consume less power in creating a desired level of on-axis illumination. Films for brightness enhancement can also be used in a wide range of other optical designs, such as for projection displays, traffic signals, and illuminated signs. Ultraviolet radiation curable (meth)acrylate compositions find use in applications such as display systems.

There remains a continuing need for further improvement in the materials used to make brightness enhancing films, particularly materials having excellent characteristics and that upon curing possess the combined attributes desired to satisfy the increasingly exacting requirements for brightness enhancing film applications.

### BRIEF DESCRIPTION

In one aspect, this invention provides a curable composition, comprising:

(a) a multifunctional (meth)acrylate represented by the structure I 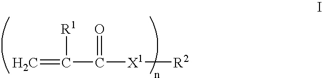
wherein R¹ is hydrogen or methyl; X¹ is independently in each instance O, S, or Se; n is 2; and R² is a divalent aromatic radical having structure II: 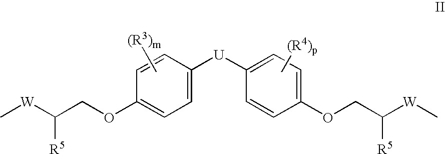
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁵ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4 inclusive; and

(b) at least one naphthyl (meth)acrylate having structure III 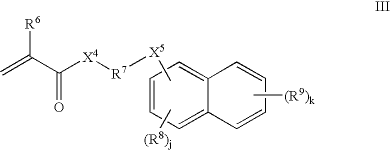
wherein R⁶ is hydrogen or methyl; X⁴ and X⁵ are independently in each instance O, S or Se; R⁷ is a divalent C₁-C₂₀ aliphatic radical, a divalent C₃-C₂₀ cycloaliphatic radical, or a divalent C₃-C₂₀ aromatic radical; R⁸ and R⁹ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; j is an integer ranging from 0 to 3 inclusive; k is an integer ranging from 0 to 4 inclusive.

In another aspect this invention relates to a cured composition comprising structural units derived from

(a) a multifunctional (meth)acrylate represented by the structure I 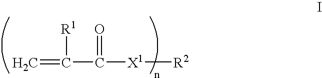
wherein R¹ is hydrogen or methyl; X¹ is O or S; n is 2; and R² is a divalent aromatic radical having structure II: 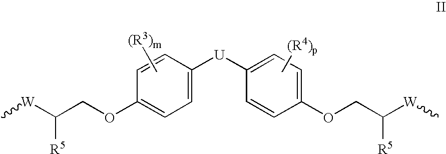
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁷ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4;

(b) at least one naphthyl (meth)acrylate having structure III 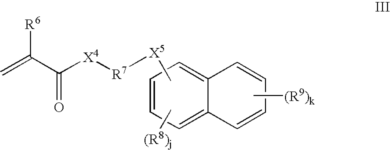
wherein R⁶ is hydrogen or methyl; X⁴ and X⁵ are independently in each instance O, S or Se; R⁷ is a divalent C₁-C₂₀ aliphatic radical, a divalent C₃-C₂₀ cycloaliphatic radical, or a divalent C₃-C₂₀ aromatic radical; R⁸ and R⁹ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; j is an integer ranging from 0 to 3 inclusive; k is an integer ranging from 0 to 4 inclusive.

In yet another aspect, this invention relates to an article comprising a cured acrylate composition, said composition comprising structural units derived from

(a) a multifunctional (meth)acrylate represented by the structure I 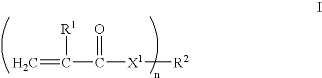
wherein R¹ is hydrogen or methyl; X¹ is O or S; n is 2; and R² is a divalent aromatic radical having structure II: 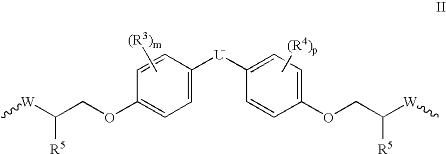
wherein U is a bond, an oxygen atom, a sulfur atom or a selenium atom, an SO₂ group, an SO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁷ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4;

(b) at least one naphthyl (meth)acrylate having structure III 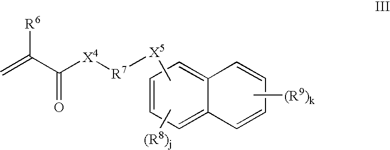
wherein R⁶ is hydrogen or methyl; X⁴ and X⁵ are independently in each instance O, S or Se; R⁷ is a divalent C₁-C₂₀ aliphatic radical, a divalent C₃-C₂₀ cycloaliphatic radical, or a divalent C₃-C₂₀ aromatic radical; R⁸ and R⁹ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; j is an integer ranging from 0 to 3 inclusive; k is an integer ranging from 0 to 4 inclusive.

### DETAILED DESCRIPTION

The terms “a” and “an” herein do not denote a limitation of quantity, but rather denote the presence of at least one of the referenced item. All ranges disclosed herein are inclusive and combinable.

As used herein, the term “integer” refers to any whole number that is not zero. As used herein, the phrase “number ranging from” refers to any number within that range, inclusive of the limits, and could be both whole numbers and fractions.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehydes groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e.—OPhC(CF₃)₂PhO—), 4-chloromethylphen-1-yl, 3-trifluorovinyl-2-thienyl, 3-trichloromethylphen-1-yl (i.e. 3-CCl₃Ph-), 4-(3-bromoprop-1-yl)phen-1-yl (i.e. 4-BrCH₂CH₂CH₂Ph-), and the like. Further examples of aromatic radicals include 4-allyloxyphen-1-oxy, 4-aminophen-1-yl (i.e. 4-H₂NPh-), 3-aminocarbonylphen-1-yl (i.e. NH₂COPh-), 4-benzoylphen-1-yl, dicyanomethylidenebis(4-phen-1-yloxy) (i.e. -OPhC(CN)₂PhO-), 3-methylphen-1-yl, methylenebis(4-phen-1-yloxy) (i.e. -OPhCH₂PhO-), 2-ethylphen-1-yl, phenylethenyl, 3-formyl-2-thienyl, 2-hexyl-5-furanyl, hexamethylene-1,6-bis(4-phen-1-yloxy) (i.e. -OPh(CH₂)₆PhO-), 4-hydroxymethylphen-1-yl (i.e. 4-HOCH₂Ph-), 4-mercaptomethylphen-1-yl (i.e. 4-HSCH₂Ph-), 4-methylthiophen-1-yl (i.e. 4-CH₃SPh-), 3-methoxyphen-1-yl, 2-methoxycarbonylphen-1-yloxy (e.g. methyl salicyl), 2-nitromethylphen-1-yl (i.e. 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e. —C₆H₁₀C(CF₃)₂ C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g. CH₃CHBrCH₂C₆H₁₀—), and the like. Further examples of cycloaliphatic radicals include 4-allyloxycyclohex-1-yl, 4-aminocyclohex-1-yl (i.e. H₂NC₆H₁₀—), 4-aminocarbonylcyclopent-1-yl (i.e. NH₂COC₅H₈—), 4-acetyloxycyclohex-1-yl, 2,2-dicyanoisopropylidenebis(cyclohex-4-yloxy) (i.e. —OC₆H₁₀C(CN)₂C₆H₁₀O—), 3-methylcyclohex-1-yl, methylenebis(cyclohex-4-yloxy) (i.e. —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e. —O C₆H₁₀(CH₂)₆C₆H₁₀O—), 4-hydroxymethylcyclohex-1-yl (i.e. 4-HOCH₂C₆H₁₀—), 4-mercaptomethylcyclohex-1-yl (i.e. 4-HSCH₂C₆H₁₀—), 4-methylthiocyclohex-1-yl (i.e. 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e. NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g. (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g. —CH₂CHBrCH₂—), and the like. Further examples of aliphatic radicals include allyl, aminocarbonyl (i.e.—CONH₂), carbonyl, 2,2-dicyanoisopropylidene (i.e. —CH₂C(CN)₂CH₂—), methyl (i.e. —CH₃), methylene (i.e. —CH₂—), ethyl, ethylene, formyl (i.e.—CHO), hexyl, hexamethylene, hydroxymethyl (i.e. —CH₂OH), mercaptomethyl (i.e. —CH₂SH), methylthio (i.e. —SCH₃), methylthiomethyl (i.e. —CH₂SCH₃), methoxy, methoxycarbonyl (i.e. CH₃OCO—), nitromethyl (i.e. —CH₂NO₂), thiocarbonyl, trimethylsilyl (i.e. (CH₃)₃Si-), t-butyldimethylsilyl, 3-trimethyoxysilypropyl (i.e. (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e. CH₃—) is an example of a C₁ aliphatic radical. A decyl group (i.e. CH₃(CH2)₉-) is an example of a C₁₀ aliphatic radical.

The phrase “(meth)acrylate monomer” refers to any of the monomers comprising at least one acrylate unit, wherein the substitution of the double bonded carbon adjacent to the carbonyl group is either a hydrogen or a methyl substitution. Examples of “(meth)acrylate monomers” include methyl methacrylate where the substitution on the double bonded carbon adjacent to the carbonyl group is a methyl group, acrylic acid where the substitution on the double bonded carbon adjacent to the carbonyl group is a hydrogen group, phenyl methacrylate where the substitution on the double bonded carbon adjacent to the carbonyl group is a methyl group, phenyl thioethyl methacrylate where the substitution on the double bonded carbon adjacent to the carbonyl group is a methyl group, ethyl acrylate where the substitution on the double bonded carbon adjacent to the carbonyl group is a hydrogen group, 2,2-bis((4-methacryloxy)phenyl)propane where the substitution on the double bonded carbon adjacent to the carbonyl group is a methyl group, and the like.

This invention is related to a curable composition comprising at least one multifunctional (meth)acrylate monomer and at least one naphthyl (meth)acrylate monomer.

In one aspect, the curable composition is a solvent-free, high refractive index, radiation curable composition that provides a cured material having an excellent balance of properties. The compositions are ideally suited for brightness enhancing film applications. In one aspect, brightness enhancing films prepared from the curable compositions exhibit good brightness.

The curable compositions comprise a multifunctional (meth)acrylate represented by the structure I 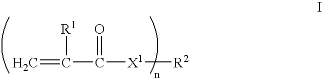
wherein R¹ is hydrogen or methyl; X¹ is O or S; n is 2; and R² is a divalent aromatic radical having structure II: 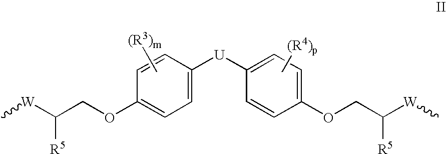
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁵ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4.

The multifunctional (meth)acrylates may include compounds produced by the reaction of acrylic or methacrylic acid with a di-epoxide, such as bisphenol-A diglycidyl ether; bisphenol-F diglycidyl ether; tetrabromo bisphenol-A diglycidyl ether; tetrabromo bisphenol-F diglycidyl ether; 1,3-bis-{4-[1-methyl-1-(4-oxiranylmethoxy-phenyl)-ethyl]-phenoxy}-propan-2-ol; 1,3-bis-{2,6-dibromo-4-[1-(3,5-dibromo-4-oxiranylmethoxy-phenyl)-1-methyl-ethyl]-phenoxy}-propan-2-ol; and the like; and a combination comprising at least one of the foregoing di-epoxides. Examples of such compounds include 2,2-bis(4-(2-(meth)acryloxyethoxy)phenyl)propane; 2,2-bis((4-(meth)acryloxy)phenyl)propane; acrylic acid 3-(4-{1-[4-(3-acryloyloxy-2-hydroxy-propoxy)-3,5,-dibromo-phenyl]-1-methyl-ethyl}-2,6-dibromo-phenoxy)-2-hydroxy-propyl ester; acrylic acid 3-[4-(1-{4-[3-(4-{1-[4-(3-acryloyloxy-2-hydroxy-propoxy)-3,5-dibromo-phenyl]-1-methyl-ethyl}-2,6-dibromo-phenoxy)-2-hydroxy-propoxy]-3,5-dibromo-phenyl}-1-methyl-ethyl)-2,6-dibromo-phenoxy]-2-hydroxy-propyl ester; and the like, and a combination comprising at least one of the foregoing multifunctional (meth)acrylates. A suitable multifunctional acrylate based on the reaction product of tetrabrominated bisphenol-A di-epoxide is RDX51027 available from Cytec Surface Specialties. Other commercially available multifunctional acrylates include EB600, EB3600, EB3605, EB3700, EB3701, EB3702, EB3703, and EB3720, all available from UCB Chemicals, or CN104 and CN120 available from Sartomer.

The curable composition further comprises a substituted or unsubstituted naphthyl (meth)acrylate monomer. A preferred substituted or unsubstituted arylether (meth)acrylate monomer is represented by the formula (III) 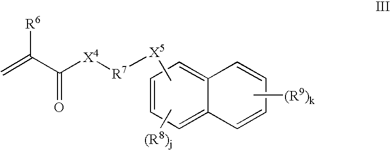
wherein R⁶ is hydrogen or methyl; X⁴ and X⁵ are independently in each instance O, S or Se; R⁷ is a divalent C₁-C₂₀ aliphatic radical, a divalent C₃-C₂₀ cycloaliphatic radical, or a divalent C₃-C₂₀ aromatic radical; R⁸ and R⁹ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; j is an integer ranging from 0 to 3 inclusive; k is an integer ranging from 0 to 4 inclusive. Particularly preferred naphthyl (meth)acrylate monomers are selected from the group consisting of 2-naphthyloxyethyl acrylate and 2-naphthylthioethyl acrylate, and mixtures thereof. The naphthyl (meth)acrylate monomers of the invention are commercially available. Alternately, they may be synthesized using standard methods known to those skilled in the art.

The curable composition may further comprise an arylether (meth)acrylate having structure V 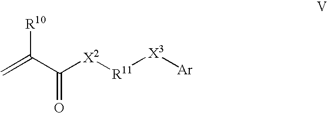
wherein R¹⁰ is hydrogen or methyl; X² and X³ are independently in each instance O or S; R¹¹ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical. As used herein, “arylether” is inclusive of both arylethers and arylthioethers, also known as arylsulfides, unless otherwise indicated. In one embodiment, the aromatic radical in the arylether (meth)acrylate monomer is a monocyclic aromatic radical. Particularly preferred substituted or unsubstituted arylether (meth)acrylate monomers are selected from the group consisting of 2-phenoxyethyl acrylate and 2-phenylthioethyl acrylate, and mixtures thereof. The substituted or unsubstituted arylether (meth)acrylate monomers of the invention are commercially available. Alternately, they may be synthesized using standard methods known to those skilled in the art.

The multifunctional (meth)acrylate is present in the curable composition in an amount of about 10 weight percent to about 70 weight percent based on the total composition. Within this range, an amount of greater than or equal to about 20 weight percent may be used, with greater than or equal to about 30 weight percent preferred, and greater than or equal to about 40 weight percent more preferred. Also within this range, an amount of less than or equal to about 65 weight percent may be used, with less than or equal to about 60 weight percent preferred, and less than or equal to about 55 weight percent more preferred.

The naphthyl (meth)acrylate monomer is present in the curable composition in an amount of about 90 weight percent to about 30 weight percent based on the total composition. Within this range, it may be preferred to use an amount of greater than or equal to about 40 weight percent, more preferably greater than or equal to about 50 weight percent.

The substituted or unsubstituted arylether (meth)acrylate monomer is present in the curable composition in an amount of about 0 weight percent to about 40 weight percent based on the total composition. Within this range, it may be preferred to use an amount of greater than or equal to about 30 weight percent, more preferably greater than or equal to about 20 weight percent.

The composition further comprises a polymerization initiator to promote polymerization of the (meth)acrylate components. Suitable polymerization initiators include photoinitiators that promote polymerization of the components upon exposure to ultraviolet radiation. Particularly suitable photoinitiators include phosphine oxide photoinitiators. Examples of such photoinitiators include the IRGACURE® and DAROCUR™ series of phosphine oxide photoinitiators available from Ciba Specialty Chemicals; the LUCIRIN® series from BASF Corp.; and the ESACURE® series of photoinitiators. Other useful photoinitiators include ketone-based photoinitiators, such as hydroxy- and alkoxyalkyl phenyl ketones, and thioalkylphenyl morpholinoalkyl ketones. Also suitable are benzoin ether photoinitiators.

The polymerization initiator may include peroxy-based initiators that may promote polymerization under thermal activation. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and combinations comprising at least one of the foregoing polymerization initiators.

The polymerization initiator may be used in an amount of about 0.01 to about 10 weight percent based on the total weight of the composition. Within this range, it may be preferred to use a polymerization initiator amount of greater than or equal to about 0.1 weight percent, more preferably greater than or equal to about 0.5 weight percent. Also within this range, it may be preferred to use a polymerization initiator amount of less than or equal to about 5 weight percent, more preferably less than or equal to about 3 weight percent.

The composition may, optionally, further comprise an additive selected from flame retardants, antioxidants, thermal stabilizers, ultraviolet stabilizers, dyes, colorants, anti-static agents, and the like, and a combination comprising at least one of the foregoing additives, so long as they do not deleteriously affect the polymerization of the composition.

The compositions provided herein comprising a multifunctional (meth)acrylate, a naphthyl (meth)acrylate monomer, an optional arylether (meth)acrylate monomer and a polymerization initiator provide materials having excellent refractive indices without the need for the addition of known high refractive index additives. Refractive index as used herein, refers to the optical property of materials that relates to the speed of light in the material. Numerically refractive index is equal to the ratio of the velocity of light in a vacuum to velocity of light in the medium. It is also equal to the ratio of the sine of the angle of incidence and the sine of the angle of refraction when a ray of light passes from air to a transparent medium.

Compositions having high refractive index, when cured to form films, provide films exhibiting excellent brightness. Brightness of a film is given in terms of luminance, which is defined as the luminous intensity of a surface in a given direction per unit area of that surface as viewed from that direction. The ratio of the intensity of the light radiation reflected off the surface of the film to intensity of incident light radiation gives the value for luminance.

The curable composition may be prepared by simply blending the components thereof, with efficient mixing to produce a homogeneous mixture. When forming articles from the curable composition, it is often preferred to remove air bubbles by application of vacuum or the like, with gentle heating if the mixture is viscous. The composition can then be charged to a mold that may bear a microstructure to be replicated and polymerized by exposure to ultraviolet radiation or heat to produce a cured article.

An alternative method includes applying the radiation curable, uncured, composition to a surface of a base film substrate, passing the base film substrate having the uncured composition coating through a compression nip defined by a nip roll and a casting drum having a negative pattern master of the microstructures. The compression nip applies a sufficient pressure to the uncured composition and the base film substrate to control the thickness of the composition coating and to press the composition into full dual contact with both the base film substrate and the casting drum to exclude any air between the composition and the drum. The base film substrate can be made of any material that can provide a sufficient backing for the uncured composition such as for example polymethyl methacrylate (i.e., PLEXIGLASS™), polyester (e.g. MYLAR™), polycarbonate (such as LEXAN™), polyvinyl chloride (VELBEX®), or even paper. In a preferred embodiment, the base film substrate comprises a polycarbonate-based material or a polyester-based material.

The radiation curable composition is cured by directing radiation energy through the base film substrate from the surface opposite the surface having the composition coating while the composition is in full contact with the drum to cause the microstructured pattern to be replicated in the cured composition layer. This process is particularly suited for continuous preparation of a cured composition in combination with a substrate.

The curable compositions are preferably cured by UV radiation. The wavelength of the UV radiation may be from about 1800 angstroms to about 4000 angstroms. Suitable wavelengths of UV radiation include, for example, UVA, UVB, UVC, UVV, and the like; the wavelengths of the foregoing are well known in the art. The lamp systems used to generate such radiation include ultraviolet lamps and discharge lamps, as for example, xenon, metallic halide, metallic arc, low or high pressure mercury vapor discharge lamp, etc. Curing is meant both polymerization and cross-linking to form a non-tacky material.

When heat curing is used, the temperature selected may be from about 80° to about 130° C. Within this range, a temperature of greater than or equal to about 90° C. may be preferred. Also within this range, a temperature of greater than or equal to about 100° C. may be preferred. The heating period may be of about 30 seconds to about 24 hours. Within this range, it may be preferred to use a heating time of greater than or equal to about 1 minute, more preferably greater than or equal to about 2 minutes. Also within this range, it may be preferred to use a heating time of less than or equal to about 10 hours, more preferably less than or equal to about 5 hours, yet more preferably less than or equal to about 3 hours. Such curing may be staged to produce a partially cured and often tack-free composition, which then is fully cured by heating for longer periods or temperatures within the aforementioned ranges. In one embodiment, the composition may be both heat cured and UV cured.

In one embodiment, the composition is subjected to a continuous process to prepare a cured film material in combination with a substrate. To achieve the rapid production of cured material using a continuous process, the composition preferably cures in a short amount of time.

Current manufacturing processes for the low cost production of cured films require rapid and efficient curing of materials followed by easy release of the cured film from the mold. The compositions comprising a multifunctional (meth)acrylate corresponding to structure I, a substituted or unsubstituted naphthyl (meth)acrylate monomer represented by formula III, an arylether (meth)acrylate corresponding to formula IV and an optional polymerization initiator have been found to efficiently cure under typical conditions employed for the rapid, continuous production of cured, coated films employing UV irradiation. Such compositions exhibit excellent relative degree of cure under a variety of processing conditions.

In one embodiment, a curable composition comprises about 10 weight percent to about 70 weight percent of a multifunctional (meth)acrylate; about 90 weight percent to about 30 weight percent of a substituted or unsubstituted naphthyl (meth)acrylate monomer; about 0 weight percent to about 15 weight percent of an arylether (meth)acrylate; and about 0.1 to about 2 weight percent of a phosphine oxide photoinitiator.

Other embodiments include articles made from any of the cured compositions. Articles that may be fabricated from the compositions include, for example, optical articles, such as films for use in back-light displays; projection displays; traffic signals; illuminated signs; optical lenses; Fresnel lenses; optical disks; diffuser films; holographic substrates; or as substrates in combination with conventional lenses, prisms or mirrors.

The invention has been described in detail with particular reference to preferred embodiments thereof, but it will be understood by those skilled in the art that variations and modifications can be effected within the spirit and scope of the invention.

### EXAMPLES

All reagents were purchased from Aldrich and used without further purification except 2-naphthalenethiol that was purchased from ACROS Organics. Diacrylate of tetrabromo bisphenol-A di-epoxide, available under the trade name RDX51027 was purchased from UCB Chemicals. 2-Phenylthioethyl acrylate, available under the trade name BX-PTEA was purchased from Bimax Company. Bis(2,4,6-trimethylbenzoyl)-phenylphosphine oxide, available under the trade name IRGACURE 819® was purchased from Ciba-Geigy. ¹H NMR spectroscopy was performed on a Bruker Avance 400 MHz NMR.

The refractive index (RI) of the liquid materials was measured using a Bausch and Lomb Abbe-3L refractometer; the wavelength associated with the measurement was 589.3 nanometers. The viscosity was measured using a Brookfield LVDV-II Cone/Plate Viscometer at 25° C., with a CPE40 or CPE51 spindle attachment, 0.5 millimeter liquid curable composition sample volume while maintaining a torque range within 15% to 90% of the equipment maximum for the specific cone attachment. The viscosity measurements are provided in centipoise (cP).

Glass transition temperatures (Tg) was measured by dynamic mechanical analysis (DMA) using a Rheometrics Solids Analyzer RSA II operating in tension with a frequency of 1.0 rad/s, strain of 0.01%, and temperature ramp of 2° C./minute. The percent (%) haze and % transmission of light through the coated cured flat films were determined according to ASTM D1003 using a BYK-Gardner Haze-guard Plus Hazemeter. The adhesion was measured for the coated cured flat film according to ASTM D3359. The color of the coated cured flat films was determined by measuring L*, a*, and b* using a Gretag Macbeth Color-Eye 7000A calorimeter using L*, a*, b* color space, the D65 illuminant, and a 10 degree observer inclusive of a specular reflection. The yellowness index (YI) of the coated cured flat films was measured using a Gretag Macbeth Color-Eye 7000A calorimeter. The refractive index (RI) of the cured films was measured with a Metricon Corporation prism coupler Model 2010 using the thick film (bulk material) setting. The curable composition is smoothly coated onto a polycarbonate substrate and cured. The cured, smooth coating is brought into direct contact with the prism without any index matching fluid. The apparatus calculates the refractive index based on the critical angle of the prism/coating interface.

Synthesis of (2-naphthyl)thioethyl acrylate (NTEA):

In a one-liter 3-necked flask equipped with nitrogen sparge, mechanical stirring and a reflux condenser, 2-naphthalenethiol (16.07 g, 0.100 mole) and ethylene carbonate (8.83 g, 0.100 mole) were dissolved in 400 milliliters toluene. A homogeneous solution was achieved after 200 milligrams of potassium carbonate (1.4 mol %) was added. The solution was brought to reflux and allowed to stir for 16 hours. ¹H NMR spectrum showed complete conversion of the 2-naphthalenethiol to the 2-naphthalenethioethanol. No other species were found in the ¹H NMR spectrum and the solution was allowed to cool to room temperature. Subsequently, to the cooled solution, triethylamine and Dimethylaminopyridine (DMAP) were added directly in a single aliquot. A solution of acryloyl chloride (13 mL, 0.16 mole) in 90 milliliters toluene was prepared. The acryloyl chloride solution was added dropwise to the reaction flask via an addition funnel while vigorous stirring was maintained in the flask. A small exotherm to 35° C. was noted with the formation of some insoluble material. After complete addition of the acryloyl chloride the solution was heated to 50° C. for 5 hours. The solution was then allowed to cool to precipitate the amine-hydrochloride salt. The salts were removed by filtration and the solution was washed with dilute HCl_{(aq)}, dilute KOH_{(aq)} and finally with brine until a pH of 6-8 was achieved. The organic layer was dried over MgSO₄, filtered and the solvent removed by rotary evaporation to yield an orange oil. The orange oil was dissolved in warm hexanes/ether mixture and slurried with carbon black. The warm solution was passed through a 3 cm bed of silica gel. The bed was extracted with hot hexanes and the organic layers were combined and dried over MgSO₄. The solution was filtered into a round-bottomed flask to which 15 mg monoethyl ether of hydroquinone (MEHQ) was added and the solvents removed by rotary evaporation to yield a low viscosity, light yellow oil.

Procedure for Film Preparation:

As used herein, coated films means a two-layered film of the composition and film substrate. Coated cured flat films having a 7 to 20 micrometer thick cured composition layer atop a 0.005-inch (0.127 centimeter) thick polycarbonate film substrate were prepared using a custom-made laminating unit and Fusion EPIC 6000 UV curing system. The laminating unit consists of two rubber rolls: a bottom variable speed drive roll and a pneumatically driven top nip roll. This system is used to press together laminate stacks that are passed between the rolls. The coated flat films were prepared by transferring approximately 0.5 mL of curable composition to a highly polished, flat, chrome-plated 5 by 7-inch (12.7 by 17.8 centimeter) steel plate in a continuous line at the front, or leading edge of the plate. A piece of substrate film was then placed over the curable composition and the resulting stack sent through the laminating unit to press and distribute the curable composition uniformly between the chrome-plate and substrate film. With higher viscosity formulations, higher pressure and lower speeds were used and the chrome-plate was heated to obtain the desired thickness. Photopolymerization of the curable composition within the stack was accomplished by passing the stack under a 600-watt V-bulb at a speed of 10 feet/minute (0.051 meters/second), using high power and a focal length of 2.1 inches (5.3 centimeter), curing through the film substrate top layer. The coated cured flat film was then peeled off of the chrome-plate and used for haze, % transmission, color, yellowness index, and adhesion measurements.

Cured free films (no film substrate) for DMA were prepared by using the same method as that described for flat films with the exception that the substrate was polyethylene. The polyethylene was the masking used to protect polycarbonate film from damage. Thus, the liquid coating was placed between the chrome plate and masked polycarbonate film with the masking side contacting the liquid. After curing, a free standing film was obtained by peeling the film from the polyethylene masking. The results of the measurements on the liquid and the films are shown in Table 1.

TABLE 1
Compositions used for brightness enhancing films and the results of the
measurements perfomed on the compositions and the films resulting
thereof.

| | Comparative | | |
|---|---|---|---|
| | Example | Example 1 | Example 2 |
| BX-PTEA (wt. %) | 49.5 | — | 24.75 |
| Naphthylthioethyl | — | 49.5 | 24.75 |
| acrylate (wt. %) | | | |
| RDX51027 (wt. %) | 50.0 | 50.0 | 50.0 |
| Irgacure 819 (wt. %) | 0.5 | 0.5 | 0.5 |
| Refractive Index of | 1.5741 | 1.615 | 1.594 |
| liquid | | | |
| Viscosity at 25C (cP) | 183 | 2,606 | 585 |
| Refractive Index of | 1.6148 | 1.646 | 1.631 |
| film | | | |
| Tg (° C.) | 41 | 57 | 51 |
| L* | 95.8 | 95.5 | 95.7 |
| a* | 0.0 | −0.1 | −0.1 |
| b* | 0.4 | 0.7 | 0.6 |
| Yellowness Index | 0.6 | 1.1 | 0.9 |
| Transmission (%) | 92.7 | 92.0 | 92.4 |
| Haze (%) | 0.71 | 4.62 | 1.06 |
| Adhesion | 5B | 5B | 5B |
| Luminance | 794.3 | 827.6 | 806.2 |
| % Luminance | 104 | 109 | 106 |

Results given in table 1 show the effectiveness of naphthylthioethyl acrylate as a partial or a complete replacement of phenylthioethyl acrylate to improve luminance, increase and modulate refractive index and Tg while maintaining adhesion to the substrate being used.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A curable composition, comprising:
(a) a multifunctional (meth)acrylate represented by the structure I 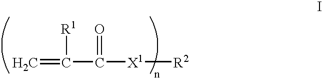
wherein R¹ is hydrogen or methyl; X¹ is independently in each instance O, S, or Se; n is 2; and R² is a divalent aromatic radical having structure II: 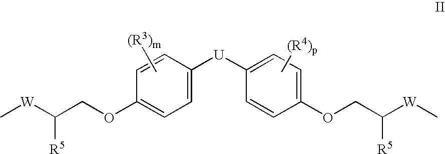
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁵ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4 inclusive; and
(b) at least one naphthyl (meth)acrylate having structure III 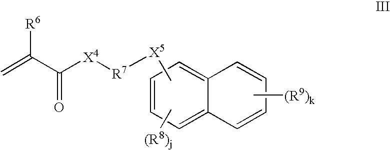
wherein R⁶ is hydrogen or methyl; X⁴ and X⁵ are independently in each instance O, S or Se; R⁷ is a divalent C₁-C₂₀ aliphatic radical, a divalent C₃-C₂₀ cycloaliphatic radical, or a divalent C₃-C₂₀ aromatic radical; R⁸ and R⁹ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; j is an integer ranging from 0 to 3 inclusive; k is an integer ranging from 0 to 4 inclusive.

2. The curable composition of claim 1, wherein the multifunctional (meth)acrylate has structure IV 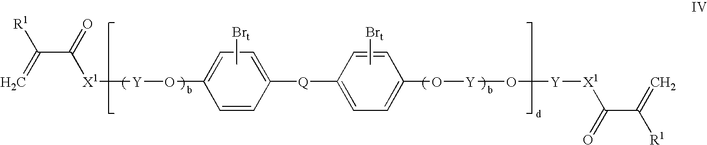
wherein R¹ is hydrogen or methyl; X¹ is O, S, or Se; Q is —C(CH₃)₂—, —CH₂—, —C(O)—, —S(O)—, or —S(O)₂—; Y is independently in each instance a C₁-C₆ aliphatic radical; b is independently in each instance a number from 1 to about 10; t is independently in each instance a number from 1 to about 4; and d is a number from 1 to about 10.

3. The curable composition of claim 2, wherein the multifunctional (meth)acrylate is the reaction product of (meth)acrylic acid with a di-epoxide comprising bisphenol-A diglycidyl ether; bisphenol-F diglycidyl ether; tetrabromo bisphenol-A diglycidyl ether; tetrabromo bisphenol-F diglycidyl ether; 1,3-bis-{4-[1-methyl-1-(4-oxiranylmethoxy-phenyl)-ethyl]-phenoxy}-propan-2-ol; 1,3-bis-{2,6-dibromo-4-[1-(3,5-dibromo-4-oxiranylmethoxy-phenyl)-1-methyl-ethyl]-phenoxy}-propan-2-ol; or a combination comprising at least one of the foregoing di-epoxides.

4. The curable composition of claim 1, further comprising at least one arylether (meth)acrylate monomer having structure V 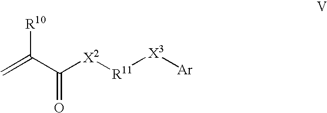
wherein R¹⁰ is hydrogen or methyl; X² and X³ are independently in each instance O or S; R¹¹ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical.

5. The curable composition of claim 4, wherein the at least one arylether (meth)acrylate monomer III is phenylthioethyl acrylate.

6. The curable composition of claim 1, wherein the at least one naphthyl (meth)acrylate monomer IV is naphthylthioethyl acrylate.

7. The curable composition of claim 1, wherein said composition has a total weight, and wherein compound I is present in an amount corresponding to from about 10% to about 70% by weight.

8. The curable composition of claim 1 further comprising a curing catalyst.

9. The curable composition of claim 1, wherein the refractive index of the composition is at least 1.5.

10. A cured composition comprising structural units derived from
(a) a multifunctional (meth)acrylate represented by the structure I 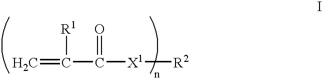
wherein R¹ is hydrogen or methyl; X¹ is O or S; n is 2; and R² is a divalent aromatic radical having structure II: 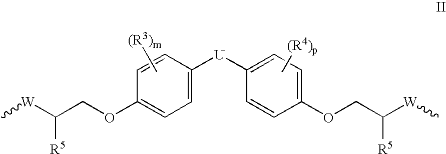
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁷ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4;
(b) at least one naphthyl (meth)acrylate having structure III 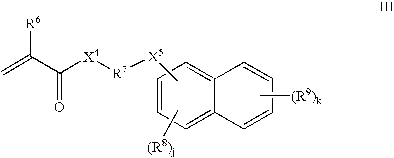
wherein R⁶ is hydrogen or methyl; X⁴ and X⁵ are independently in each instance O, S or Se; R⁷ is a divalent C₁-C₂₀ aliphatic radical, a divalent C₃-C₂₀ cycloaliphatic radical, or a divalent C₃-C₂₀ aromatic radical; R⁸ and R⁹ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; j is an integer ranging from 0 to 3 inclusive; k is an integer ranging from 0 to 4 inclusive.

11. The cured composition of claim 10, wherein the multifunctional (meth)acrylate has structure IV 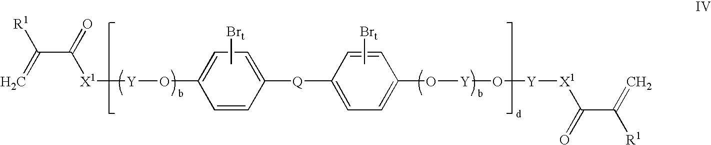
wherein R¹ is hydrogen or methyl; X¹ is O or S; Q is —C(CH₃)₂—, —CH₂—, —C(O)—, —S(O)—, or —S(O)₂—; Y is independently in each instance a C₁-C₆ aliphatic radical; b is independently in each instance a number from 1 to about 10; t is independently in each instance a number from 1 to about 4; and d is a number from 1 to about 10.

12. The cured composition of claim 11, wherein the multifunctional (meth)acrylate is the reaction product of (meth)acrylic acid with a di-epoxide comprising bisphenol-A diglycidyl ether; bisphenol-F diglycidyl ether; tetrabromo bisphenol-A diglycidyl ether; tetrabromo bisphenol-F diglycidyl ether; 1,3-bis-{4-[1-methyl-1-(4-oxiranylmethoxy-phenyl)-ethyl]-phenoxy}-propan-2-ol; 1,3-bis-{2,6-dibromo-4-[1-(3,5-dibromo-4-oxiranylmethoxy-phenyl)-1-methyl-ethyl]-phenoxy }-propan-2-ol; or a combination comprising at least one of the foregoing di-epoxides.

13. The cured composition of claim 10, further comprising at least one arylether (meth)acrylate monomer having structure V 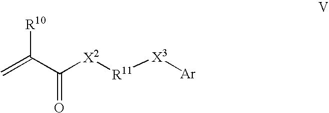
wherein R¹⁰ is hydrogen or methyl; X² and X³ are independently in each instance O or S; R¹¹ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical.

14. The cured composition of claim 13, wherein the at least one arylether (meth)acrylate monomer III is phenylthioethyl acrylate.

15. The cured composition of claim 10, wherein the at least one naphthyl (meth)acrylate monomer IV is naphthylthioethyl acrylate.

16. The cured composition of claim 10, wherein said composition has a total weight, and wherein compound I is present in an amount corresponding to from about 10% to about 70% by weight.

17. The cured composition of claim 10 further comprising a curing catalyst.

18. The cured composition of claim 10, wherein the refractive index of the composition is at least 1.6.

19. A curable composition, consisting essentially of:
(a) a multifunctional (meth)acrylate represented by the structure I 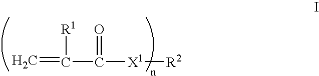
wherein R¹ is hydrogen or methyl; X¹ is O or S; n is 2; and R² is a divalent aromatic radical having structure VII: 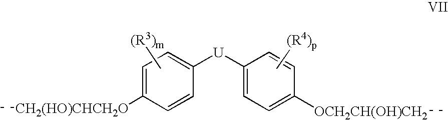
wherein U is a bond, an oxygen atom, a sulfur atom or a selenium atom, an SO₂ group, an SO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; m and p are integers ranging from 0 to 4;
(b) at least one naphthyl (meth)acrylate having structure III 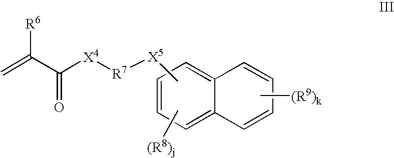
wherein R⁶ is hydrogen or methyl; X⁴ and X⁵ are independently in each instance O, S or Se; R⁷ is a divalent C₁-C₂₀ aliphatic radical, a divalent C₃-C₂₀ cycloaliphatic radical, or a divalent C₃-C₂₀ aromatic radical; R⁸ and R⁹ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; j is an integer ranging from 0 to 3 inclusive; k is an integer ranging from 0 to 4 inclusive.

20. The curable composition of claim 19, further comprising a at least one arylether (meth)acrylate monomer having structure V 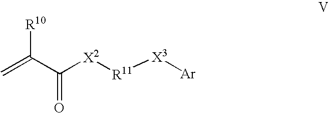
wherein R¹⁰ is hydrogen or methyl; X² and X³ are independently in each instance O or S; R¹¹ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical.

21. An article comprising a cured acrylate composition, said composition comprising structural units derived from
(a) a multifunctional (meth)acrylate represented by the structure I 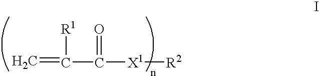
wherein R¹ is hydrogen or methyl; X¹ is O or S; n is 2; and R² is a divalent aromatic radical having structure II: 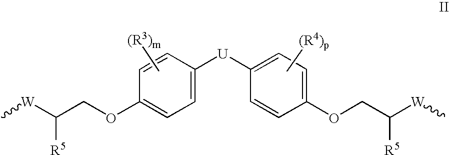
wherein U is a bond, an oxygen atom, a sulfur atom or a selenium atom, an SO₂ group, an SO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁷ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4;
(b) at least one naphthyl (meth)acrylate having structure III 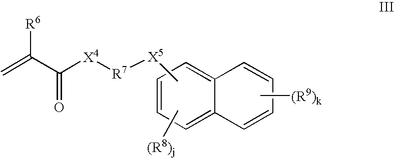
wherein R⁶ is hydrogen or methyl; X⁴ and X⁵ are independently in each instance O, S or Se; R⁷ is a divalent C₁-C₂₀ aliphatic radical, a divalent C₃-C₂₀ cycloaliphatic radical, or a divalent C₃-C₂₀ aromatic radical; R⁸ and R⁹ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; j is an integer ranging from 0 to 3 inclusive; k is an integer ranging from 0 to 4 inclusive.

22. The article according to claim 21 which is an optical film.

23. The article according to claim 21, said article being a multilayer article comprising a substrate selected from the group consisting of glass, and thermoplastic materials.

24. The article according to claim 23 wherein said substrate is a thermoplastic material.

25. An article according to claim 24 wherein said substrate is polycarbonate or a polyester.
